(19) United States
(12) Patent Application Publication
(10) Pub. No.: US 2012/0330920 A1
(43) Pub. Date: Dec. 27, 2012

(54) TYPED SEARCH TO ASSIST WITH BUYING AND SELLING ACTIVITIES

(76) Inventors: Kaviraj Singh, Kirkland, WA (US); Sandeep Agarwal, Kirkland, WA (US); Predeep Singh Rajpoot, Kirkland, WA (US)

(21) Appl. No.: 13/526,797

(22) Filed: Jun. 19, 2012

Related U.S. Application Data
(60) Provisional application No. 61/499,602, filed on Jun. 21, 2011.

(51) Int. Cl. G06F 17/30

(52) U.S. Cl. 707/706; 707/E17.015

(57) ABSTRACT

The current application is directed to characterization of e-commerce-related searches and digital encoding of the characterizations in a database or other data-storage system by an e-commerce search engine. As one example, when a user enters a query term in a search textbox, the user is provided with a choice of pressing an action button labeled “I want to buy” or an action button labeled “I want to sell,” referred to as a “buy button” and “sell button,” respectively. The search engine records the buy-button and sell-button inputs along with corresponding search queries. The search-engine implementation then collects these queries from a large number of users into a database and matches them over a period of time, thus helping buyers find sellers and vice versa.

### CROSS-REFERENCE TO RELATED APPLICATION

This application claims the benefit of Provisional Application No. 61/499,602, flied Jun. 21, 2011.

### TECHNICAL FIELD

The present invention is related to automated search systems and, in particular, to a full-text searching system that asks the user to explicitly provide the purpose of his or her search.

### BACKGROUND

Retailing and purchasing goods and services via the Internet has grown, during the past 20 years, into an enormous world-wide marketplace. While Internet commerce, or e-commerce, has evolved and matured over this time frame, researchers and developers continue to design, develop, and deploy new technologies and systems to facilitate e-commerce and expand the capabilities of e-commerce-related tools, services, and systems.

### SUMMARY

The current application is directed to characterization of e-commerce-related searches and digital encoding of the characterizations in a database or other data-storage system by an e-commerce search engine. As one example, when a user enters a query term in a search textbox, the user is provided with a choice of pressing an action button labeled “I want to buy” or an action button labeled “I want to sell,” referred to as a “buy button” and “sell button,” respectively. The search engine records the buy-button and sell-button inputs along with corresponding search queries. The search-engine implementation then collects these queries from a large number of users into a database and matches them over a period of time, thus helping buyers find sellers and vice versa.

### BRIEF DESCRIPTION OF THE DRAWINGS

FIG. 1 shows an example user interface of a search engine that provides a typed-search facility.

FIG. 2 shows the query results of the query shown in FIG. 1 presented in a multi-tabbed interface, or dashboard.

FIG. 3 shows a high-level dataflow for an example search-engine that provides a typed-search facility.

FIG. 4 shows the basic schema of the leads table.

FIG. 5 shows the basic interaction model between two users working with one example of the system over time, along with the evolution of database state in response to their operation.

### DETAILED DESCRIPTION

The current application is directed to a typed-search facility provided by an e-commerce-related search engine that, when used by search-engine users, allows users to gain precisely matched buyers or sellers for their selling or buying needs. Further, the search interface records typed queries in a database.

In the following discussion, the terms “query,” “query type,” “buy lead,” “sell lead,” and standing query” are used as follows:

Query: A text string entered by a user into a textbox of a search interface, followed by inputting an input to a buy button or to a sell button. For example, a user entering “Fine garments” and inputting an input to a buy button generates the query: (“Fine garments,” BUY).

Query type: BUY or SELL, depending on whether the user inputs an input indication to a buy button or to a sell button.

Buy lead: a BUY-type query stored in a database.

Sell lead: a SELL-type query stored in a database.

Standing query: Either a Buy lead or a Sell lead stored in the database

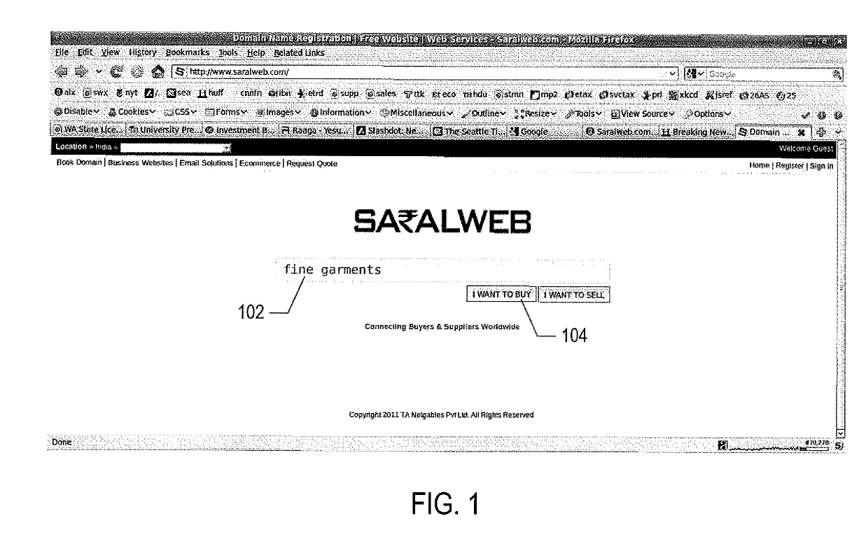

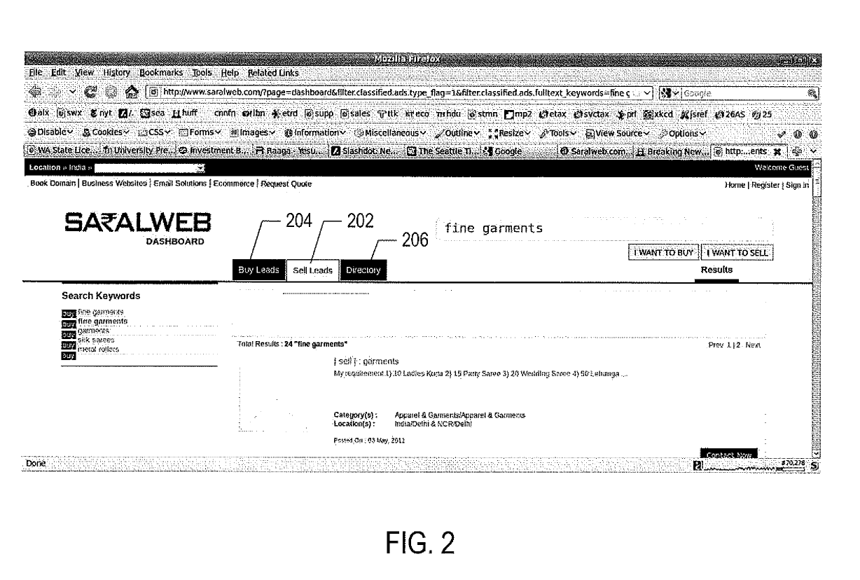

FIG. 1 shows an example user interface of a search engine that provides a typed-search facility. As shown in FIG. 1, the user has entered a query 102 for “fine garments” and intends to input a mouse click to the buy button 104. FIG. 2 shows the query results of the query shown in FIG. 1 presented in a multi-tabbed interface, or dashboard. Since the user has entered input to the buy button, the dashboard opens on the tab “sell leads,” 202 displaying results that match the user's query, via full text search, entered in association with input to a sell button. The user may also view corresponding buy leads 204 and trade directory results 206. Had the user instead input to the sell button, the dashboard would have opened on the “buy leads” tab. The user may return frequently to the dashboard to check whether there have been any further responses to the user's query. In the example above, when other users enter garment-related queries using the sell button, they will translate into future “sell leads” for this query.

In one example, the user interface consists of two web pages: a homepage and a dashboard page. The homepage is an HTML form which returns the query entered by the user via two input fields:

search text (name): contents of the textbox

search type (type): which button was pressed, BUY or SELL

The dashboard is also an HTML form, which primarily displays results of a search or searches entered by the user. The dashboard also allows performs additional searches via a smaller version of the search interface on the top right. The dashboard UI consists of three tabs: (1) buy leads; (2) sell leads; and (3) trade directory. When a user inputs to the buy button, the dashboard opens on the sell leads tab and displays matching leads of type SELL. When a users inputs to the sell button, the dashboard opens on the buy leads tab and displays matching leads of type BUY.

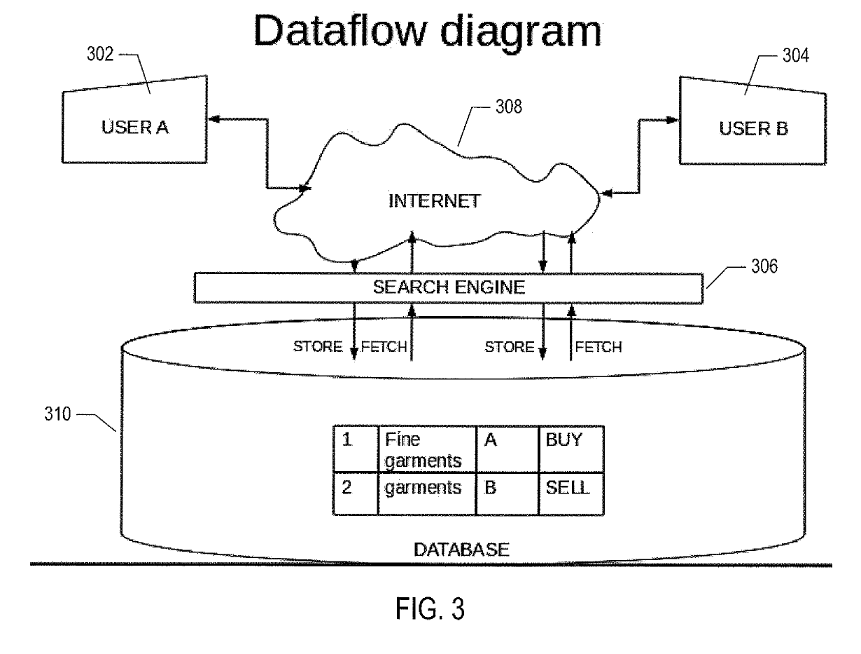

FIG. 3 shows a high-level dataflow for an example search-engine that provides a typed-search facility. The diagram is shown with reference to multi-user operation. Two users A 302 and B 304 are shown interacting with the system 306 over the internet 308. Both user A's and user B's queries are stored in the database 310 in the leads table by the search engine, which also uses the same database to fetch results for user A's and user B's queries. Subsequent sections describe the operation of the leads store and fetch operations.

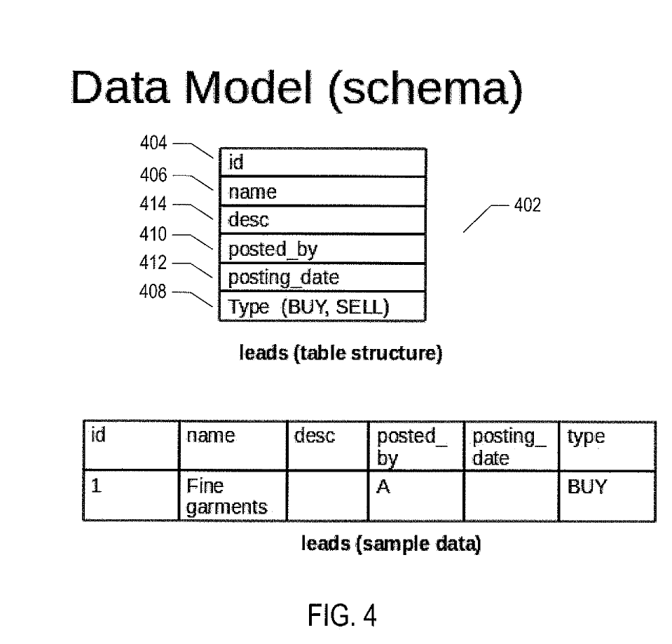

FIG. 4 shows the basic schema of the leads table. FIG. 4 shows data definitions for the leads table 402 as well as a sample data record created when user A searches for “Fine garments” and hits the buy button.

Leads are stored with a unique ID 404 in the leads table. A query, as entered by a user, becomes the name 406 of the lead and the type of button pressed by the user becomes the type 408 (BUY or SELL) of the lead. The lead record further contains information pertaining to who posted the lead (posted_by) 410 and the date posted (posting_date) 412. Finally, the user may add extra text to the lead as desc 414.

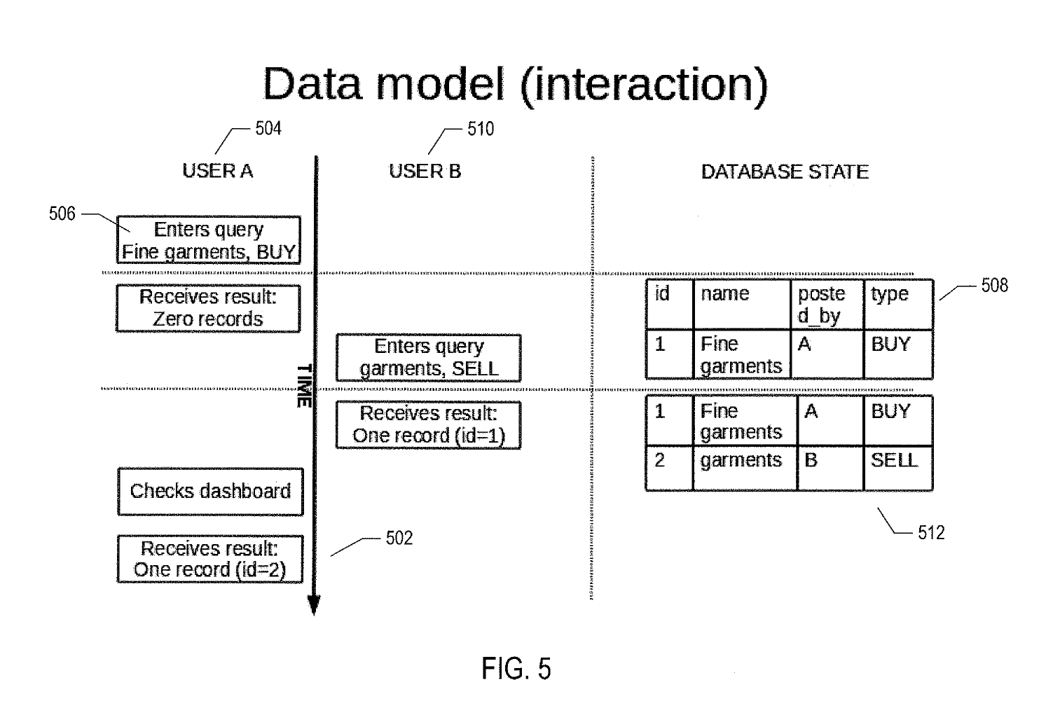

FIG. 5 shows the basic interaction model between two users working with one example of the system over time, along with the evolution of database state in response to their operation. The thick vertical line arrow 502 moving down the left half of the figure represents the flow of time. The database is assumed to be initially empty. User A 504 starts off by searching for “Fine garments” 506 and inputting to the buy button. As shown in the interaction diagram, this immediately creates a lead record 508 with ID=1 and with the query (“Fine garments,” BUY) in the database. User A, however, does not receive results at this time, since there is no matching sell lead in the database. After some time, User B 510 enters a query on “garments” and inputs to the sell button. This creates the lead record 512 with ID=2 and with query (garments, “SELL”) in the database. Further, user B receives a single result in the dashboard (record ID=1) which is a matching BUY lead to the user's query. Later, User A comes back to his dashboard to check for results. At this time, user A receives one result (record with ID=2) which is the matching SELL lead entered by user B. The matching of leads is based on the keywords in name fields, using a standard-text search mechanism available in industry standard SQL servers. An example implementation uses Postgres SQL.

The Typed Search has the following features:

Use of action-oriented buttons (buy, sell) in a general purpose search interface

Storage of past queries to generate results for new queries, in a transaction matching sense

Long-term display of search results using a dashboard interface, thus letting a user come back for new results over time

The typed search is more focused than general-purpose text search in its scope, thus yielding more relevant results. Storage of past queries provides an ability to match buyers to sellers, which is not provided by traditional text-search implementations. Providing search results in a dashboard interface allows users to take advantage of their searching effort over a long period of time, and to therefore increase their chances of a successful sale or purchase.

1. A search system comprising:
a computer system connected to remote users via the Internet and including one or more processors and memory;
a user interface that includes a text-string entry feature for entering text-based queries as well as a buy feature and a sell feature that, when selected, appends a BUY type indication or a SELL type indication, respectively, to the text string to form a query;
a search engine; and
a search database.
